(19) United States
(12) Patent Application Publication
(10) Pub. No.: US 2019/0213467 A1
(43) Pub. Date: Jul. 11, 2019

(54) ARCHITECTURE FOR IMPLEMENTING AN IMPROVED NETWORK

(71) Applicant: IOTELLIGENT TECHNOLOGY LTD INC, Irvine, CA (US)

(72) Inventors: Theodore ZHU, Mission Viejo, CA (US); Bin ZHAO, Irvine, CA (US)

(21) Appl. No.: 16/357,086

(22) Filed: Mar. 18, 2019

Related U.S. Application Data
(63) Continuation-in-part of application No. 14/271,137, filed on May 6, 2014, now Pat. No. 10,235,621.
(60) Provisional application No. 61/820,379, filed on May 7, 2013.

(51) Int. Cl. G06N 3/04; G06N 3/063; G06K 19/07; H04L 29/08

(52) U.S. Cl. CPC G06N 3/04; H04L 67/104; G06K 19/0723; G06N 3/063

(57) ABSTRACT

Disclosed is an improved approach to implement artificial neural networks. According to some approaches, an advanced neural network is implemented using an internet-of-things methodology, in which a large number of ordinary items having RFID technology are utilized as the vast infrastructure of a neural network. In one approach, the artificial iotons are constructed using a wireless terminal, such as mobile phones, tablets, laptops and WiFi base units that becomes associated with RFID tags. These artificial iotons forms connections with other iotons using wireless technology. An ioton and method of use therefore are also provided, in which the ioton is participated into primary and shareable resources for improved access management to a remote device when forming a distributed processing network, such as a neural network.

### CROSS REFERENCE TO RELATED APPLICATION(S)

The present application is a continuation-in-part of U.S. patent application Ser. No. 14/271,137, filed on May 6, 2014, now issued as U.S. patent Ser. No. 10/235,621, which claims the benefit of priority to U.S. Provisional Patent Application Ser. No. 61/820,379, entitled “Architecture for Implementing an Improved Neural Network”, filed on May 7, 2013, which are all hereby incorporated by reference in their entirety.

### BACKGROUND

The term neural network often refers to artificial neural networks, which are composed of networked neurons or nodes. The term may refer to either biological neural networks or artificial neural networks for solving artificial intelligence problems.

A neural network is an information processing paradigm inspired by the way biological neural systems process data. The intent of many neural network networks is to be able to replicate the functional abilities of a biological neural network, which is typically composed of a group or groups of chemically connected or functionally associated neurons. A single neuron may be connected to many other neurons and the total number of neurons and connections in a network may be extensive.

It would be of great benefit to be able to implement an artificial neural network. The artificial neural networks may be used for many purposes. For example, neural networks can be used to perform predictive modeling, adaptive control, and many other types of analytical applications.

There have been many attempts in the past to use computing technologies to implement neural networks. However, past approaches to use computers failed to achieve desired performance levels because computers are just not sophisticated or complex enough to effectively replicate biological neural networks.

Therefore, there is a need for an improved approach to implement artificial neural networks that provides usable performance capabilities, and which can effectively replicate the sophistication and complexity of biological neural networks.

### SUMMARY

The invention pertains to an improved approach to implement artificial neural networks. According to some embodiments of the invention, an advanced neural network is implemented using an internet-of-things methodology, in which a large number of ordinary items are utilized as the vast infrastructure of a neural network. The ordinary items are equipped with RFID tags to allow them to participate as part of the neural network. Artificial iotons are constructed using a DPU (distributed process unit) that becomes associated with RFID tags. These artificial iotons forms connections with other iotons, where over time, a huge network of connections are formed.

In some embodiments, the artificial iotons are constructed using a wireless terminal (WT), such as mobile phones, tablets, laptops and WiFi base units that becomes associated with RFID tags. These artificial iotons forms connections with other iotons using wireless technology.

Some embodiments provide an improved architecture, method, and computer program product for implementing an ioton and method of use therefore, in which the ioton is participated into primary and shareable resources for improved access management to a remote device when forming a distributed processing network, such as a neural network.

Other and additional objects, features, and advantages of the invention are described in the detailed description, figures, and claims.

### BRIEF DESCRIPTION OF FIGURES

The present invention is illustrated by way of example, and not by way of limitation, in the figures of the accompanying drawings and in which like reference numerals refer to similar elements and in which:

FIGS. 1A and 1B illustrate artificial iotons in accordance with some embodiments.

FIG. 2A illustrates an architecture of a neural network in accordance with some embodiments.

FIG. 2B illustrates a pairing between two iotons in accordance with some embodiments.

FIGS. 2C-2E show different types of architectures that may be used to implement a neural network in accordance with some embodiments.

FIG. 3 illustrates an architecture of a DPU in accordance with some embodiments.

FIG. 4 illustrates a flowchart of a process for implementing a neural network in accordance with some embodiments.

FIG. 5 illustrates a bandwidth allocation scheme for DPU pairings in accordance with some embodiments.

FIG. 6 illustrates a block diagram of an example architecture for another embodiment of a DPU/WT.

FIG. 7 shows a flowchart of an approach for providing access/control to a remote ioton according to some embodiments of the invention.

FIG. 8 shows a flowchart of an approach to determine whether or not an access request should be granted to local resources for a remote ioton.

FIGS. 9A-G illustrate an embodiment of the invention.

### DETAILED DESCRIPTION

Various embodiments are described hereinafter with reference to the figures. It should be noted that the figures are not drawn to scale and that the elements of similar structures or functions are represented by like reference numerals throughout the figures. It should be noted that the figures are only intended to facilitate the description of the embodiments. They are not intended as an exhaustive description of the invention or as a limitation on the scope of the invention. In addition, an illustrated embodiment need not have all the aspects or advantages shown. An aspect or an advantage described in conjunction with a particular embodiment is not necessarily limited to that embodiment and can be practiced in any other embodiments even if not so illustrated. Also, reference throughout this specification to “some embodiments” or “other embodiments” means that a particular feature, structure, material, or characteristic described in connection with the embodiments is included in at least one embodiment. Thus, the appearances of the phrase “in some embodiment” or “in other embodiments” in various places throughout this specification are not necessarily referring to the same embodiment or embodiments. In addition, for the purposes of illustration and explanation, the present disclosure is described in various embodiments in the context of mobile applications that receive additional role and environment information. It is noted, however, that the invention is not limited in its scope to these types of applications and this set of additional information, and indeed, may be applied to other types of applications and information as well.

The invention pertains to an improved approach to implement artificial neural networks. As a baseline set of objectives, there are numerous elements that can or should exist within an artificial neural network so that the neural network can provide usable performance capabilities, and which effectively allows the artificial neural network to replicate the sophistication and complexity of biological neural networks.

First, the neural network should be able to provide memory elements having the ability to store data. Intelligent behavior for the neural network is premised upon the ability to perform certain actions, such as analytical or reactive actions, which often depend upon access to memory.

Second, the neural network should be able to provide and/or have access to sensory inputs. Such sensory inputs may analogize to the types of sensory inputs available to the biological brain. For example, such sensory inputs may relate to vision inputs, sound inputs, touch inputs, motion inputs, etc.

Third, the neural network should provide an approach that allows a network to form between neural elements (artificial neurons). The network should be adaptive enough so that the neural elements can connect as needed and in adaptive patterns to implement “learning” processes.

Fourth, the neural network must be large enough to provide for a very large number of neurons. A biological neural network (such as a human brain) has many billions of biological neurons forming trillions of connections. To even come close to replicating this type of biological neural network, the artificial neural network should also similarly have an extremely large number of artificial neurons with the capability for trillions of connections. In the preferred embodiment, the processing power of the artificial neural network should even exceed the number of neurons that exist in a biological network.

According to some embodiments of the invention, an advanced neural network is implemented using an internet-of-things methodology and/or other types of wireless technology/networks, in which a large number of ordinary items are utilized as the vast infrastructure of a neural network. The ordinary items are equipped, e.g., with RFID tags to allow them to participate as part of the neural network. These RFID tags include memory components, which allow the RFID tags to implement the first requirement stated above of the memory elements.

According to embodiments of the invention, multiple ones of the RFID tags are accessed and organized by an RFID reader/writer device to form artificial “iotons”, which are physical embodiments of a neuron. According to certain embodiments of the invention, multiple ones of the RFID tags are accessed and organized by a wireless terminal, such as mobile phones, tablets, laptops and WiFi base units, to form the artificial iotons. The iotons are associated with sensors (such as MEMS sensors) to allow for sensory inputs. These sensors therefore satisfy the second requirement stated above for the sensory inputs.

In the current embodiment, the iotons form peer-to-peer network connections with other iotons. This satisfies the third requirement stated above, where the neural network should provide an approach that can allow a network to form between neural elements. The peer-to-peer connections can be formed as desired or necessary, thereby allowing for adaptive patterns to form between the iotons.

Lastly, the fourth requirement states that the neural network should be large enough to provide for a very large number of artificial neurons. RFID technologies and/or other types of wireless technology are now being implemented into very large numbers of items that are distributed just about everywhere around the world and will be located in all manners of goods and products. Some embodiments of the present invention implements the artificial neurons using the RFID technologies that are being implemented in such large numbers. Therefore, the sheer number of items that will include RFID and/or other wireless technologies will allow the invention to implement an architecture for a neural network having a sufficient number of artificial neurons to replicate (and even eventually exceed) a biological neural network. In addition, other types of wireless technology, such as wireless cellular and WiFi terminals (mobile or fixed), are also widely implemented all over the world today, and embodiments of the invention can implement the artificial neurons using the RFID technologies and/or wireless cellular/WiFi terminals.

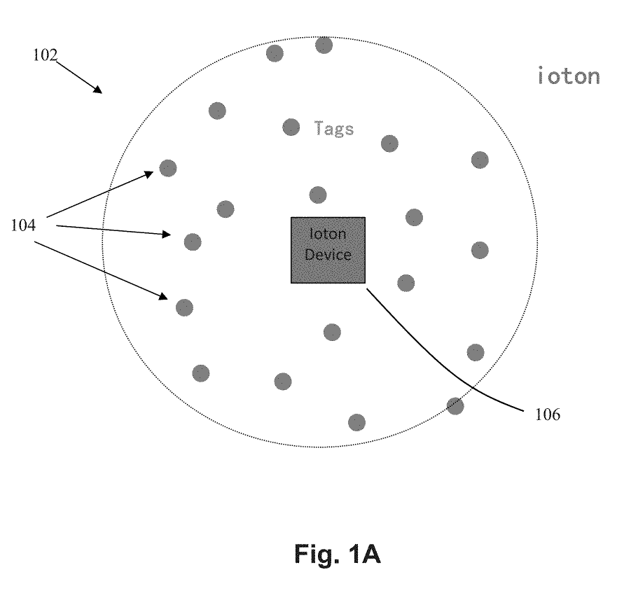

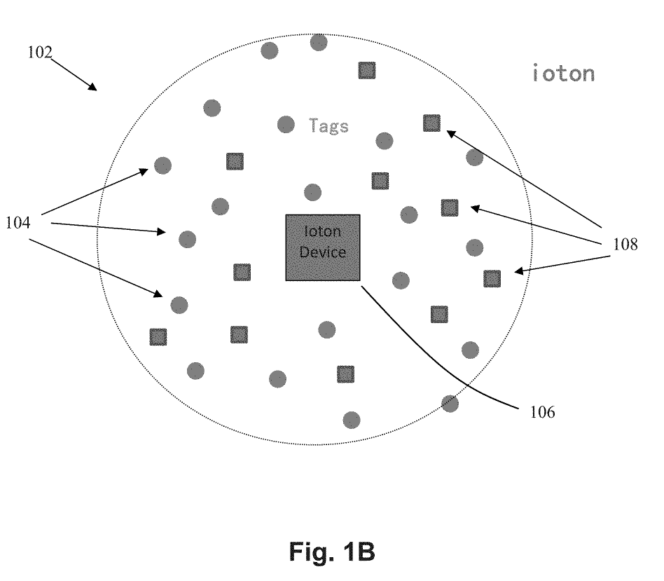

FIG. 1A illustrates an example ioton 102 according to some embodiments of the invention. The ioton 102 comprises a distributor process unit (DPU) 106 (which may also be referred to as an ioton device and/or wireless terminal (WT)) having functionality to perform reading and writing to RFID tags 104. It is the combination of the DPU 106 along with nearby RFID tags 104 that form the ioton 102 (which corresponds to a physical embodiment of a neuron).

The RFID tags 104 each may include a memory component, such as an EEPROM memory component. The RFID tags may be either powered or non-powered. In some embodiments, the RFID tag 104 comprises a passive tag having non-volatile memory. The RFID tag in some embodiments may comprise SRAM memory components.

Each DPU 106 has a certain radius in which it is able to access RFID tags 104. For example, where the DPU 106 uses a 900 MHz ISO 180000-6 protocol to access RFID tags 104, the radius of access to RFID tags 104 may correspond to about 10 meters. Therefore, the RFID tags 104 within that radius provide the memory for the ioton 102. It is noted that any suitable communications protocol or frequency may be used to communicate between the DPU 106 and the RFID tags 104, and therefore the communication is not limited to the 900 MHz frequency or the specific protocol specified above.

The DPU 106 can correspond to one or more sensor devices. In some embodiments, the sensor devices comprise MEMS sensors for speed, acceleration, temperature, moisture, sound, light/image/video capture, chemical detection, GPS location, and/or any other suitable or appropriate sensing functionality.

In some embodiments, DPU 106 may access different types of tags and sensors through different types of communications protocols. For example, FIG. 1B illustrates a DPU 106 configured to be able to communicate with a plurality of RFID tags 104 and a plurality of external sensor systems 108. Sensor systems 108 may comprise any type of device capable of sensing an environmental condition, such as speed, acceleration, temperature, moisture, sound, light/image/video capture, chemical detection, GPS location, electrical signals, etc. In addition, sensor systems 108 may in some embodiments comprise an input device upon which a user may enter one or more inputs. DPU 106 may communicate with RFID tags 104 and sensors systems 108 using different communications protocols. For example, in some embodiments, DPU 106 communicates with RFID tags 104 using UHF (ultra high frequency) RFID protocols, and communicates with sensor systems 108 using a ZigBee protocol (e.g., sensor systems 108 are ZigBee modules).

In some embodiments, sensor systems 108 may be located on or integrated with RFID tags 104, such that DPU 106 is able to communicate with them using RFID protocols. In some embodiments, RFID tags 104 may be passive, consuming little or no power when not communicating with DPU 106 or other RFID devices.

It is noted that any suitable communications protocol or frequency, or combination of protocols or frequencies, may be used to communicate between the DPU 106, the RFID tags 104, and the sensor systems 108, and that the communication is not limited to any specific protocol specified above (e.g., UHF RFID and ZigBee).

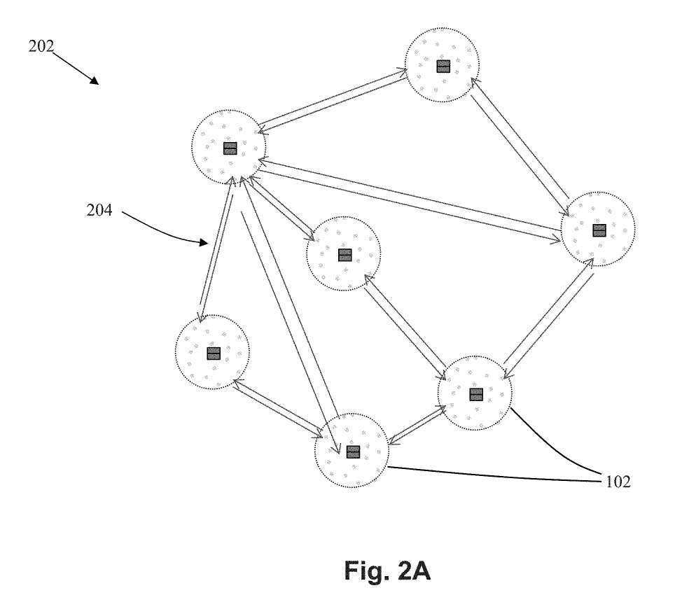

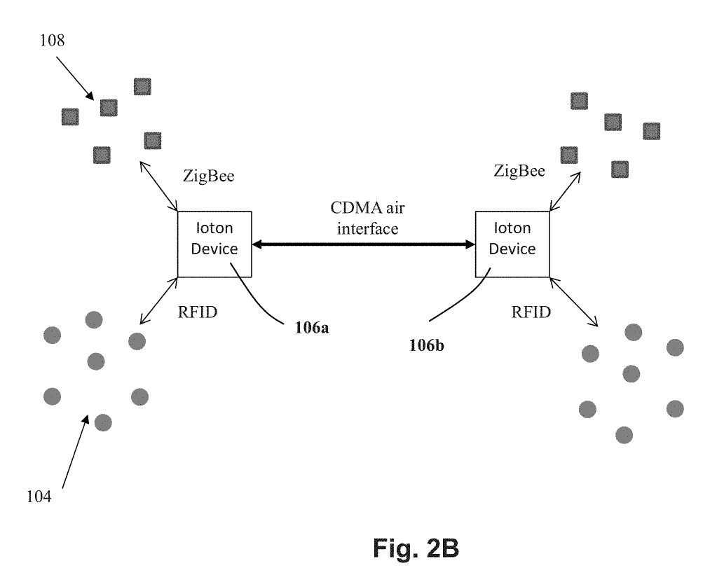

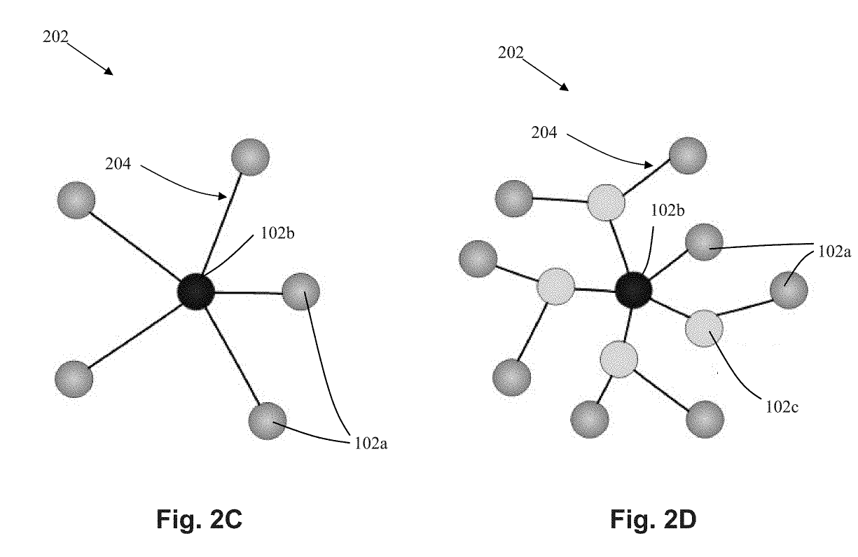

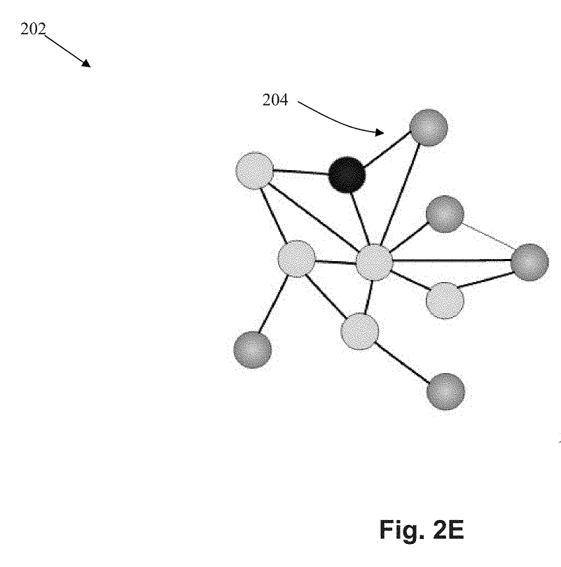

FIG. 2A illustrates an architecture of an artificial neural network 202 according to some embodiments of the invention. In this architecture, each ioton 102 can make a network pairing 204 with any neighboring ioton 102. Each ioton 102 is capable of making a pairing 204 with any other ioton 102 within its networking range.

Any suitable networking protocol or frequency can be used to make the pairing. In some embodiments, mesh networking methodologies are performed to implement the pairings. One example mesh network approach is to use the 6lowpan protocol to implement pairing between one ioton and another ioton.

In some embodiments, DPUs 106 of iotons 102 may communicate through an air interface, such as a CDMA (code division multiple access) interface. The specific interface used may be based upon standards of a location in which the artificial neural network 202 is based (e.g., TD-SCDMA in China, CDMA2000 in the United States, W-CDMA in Japan). In some embodiments, a frequency range for the air interface is chosen such that it does not interfere with cellular communications. In addition, the frequency range may be sub-divided into a plurality of frequency sub-ranges, allowing for a given DPU to be part of a plurality of different artificial neural networks corresponding to the different sub-ranges. The size of each sub-range may be configured depending upon the needs of the network, wherein a wider frequency sub-range allows for greater bandwidth and higher data throughput.

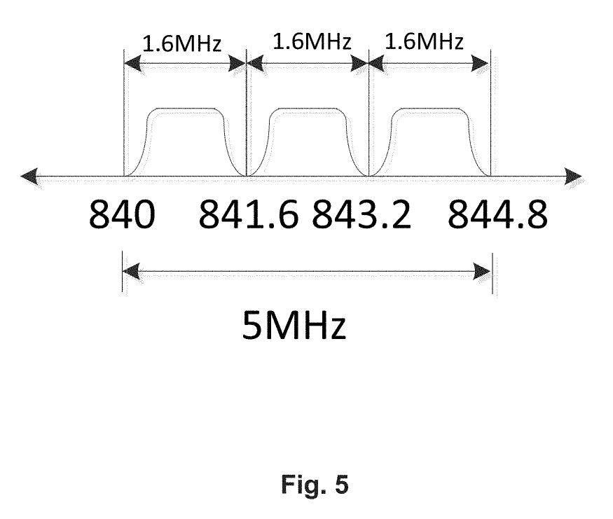

For example, in China, TD-SCDMA is typically run in the frequency ranges of 2010 MHz to 2025 MHz and 1880 MHz to 1900 MHz, used for voice communication, while the frequency ranges of 920 MHz to 925 MHz and 840 MHz to 845 MHz are reserved for RFID communications. However, typical RFID communications are on the range of 920 MHz to 925 MHz, and not on the range of 840 MHz to 845 MHz. Therefore, in some embodiments, the air interface between DPUs is configured to be in the frequency range of 840 MHz to 845 MHz. In addition, this 5 MHz range may be divided into three sub-ranges of 1.6 MHz each, as illustrated in FIG. 5, wherein the frequency range of 1.6 MHz is selected to allow for sufficient data throughput for the network. Thus the DPU may be a part of up to three distinct artificial neural networks.

FIG. 2B illustrates a pairing between two DPUs 106a and 106b of two different iotons in accordance with some embodiments. DPUs 106a and 106b are each configured to communicate with a plurality of RFID tags 104 using UHF RFID (e.g., operating in the 920 MHz to 925 MHz frequency range), and a plurality of sensor systems 108 using ZigBee protocols. In addition, DPUs 106a and 106b are able to communicate with each other through a TD-SCDMA air interface (e.g., operating in the 2010 MHz to 2025 MHz and/or 840 MHz to 845 MHz frequency range).

Similar to biological neurons that make connections with neighboring neurons through adaptive learning, the ioton 102 is capable of using mesh networking to make connections 204 to other iotons 102 on an adaptive basis. Rules can be implemented to manage and track pairings, where the rules are either predetermined and/or programmable.

The iotons 102 can have different types and/or sets of configurations. For example, the iotons 102 may have differing numbers of tag and/or different types/numbers of sensors. The iotons 102 may also have differing numbers of pairings to other iotons 102. While the term “pairing” is utilized to indicate a connection between two iotons, it is noted that some embodiments can provide for networking protocols in which different numbers of iotons are “paired” together.

The organization of artificial neural network 202 may have a form in accordance with one or more rules. In some embodiments, iotons 102 may be arranged in a “star” configuration, as illustrated in FIG. 2C, wherein a plurality of leaf iotons 102a connect to a central ioton 102b. In this configuration, all communications between iotons in the artificial neural network 202 pass through central ioton 102b. As a result, central ioton 102b may devote a larger proportion of its processing power towards handling communications, and may have less processing power for computation and other processing. In other embodiments, iotons 102 may be arranged in a “tree” configuration, as illustrated in FIG. 2D, wherein artificial neural network is arranged into a plurality of branches connected by a central ioton 102b, wherein each branch contains a plurality of branch iotons 102c and leaf iotons 102a. It is noted that although the illustrated embodiment shows only one level of branch iotons 102c, an artificial neural network 202 in a “tree” configuration may contain many levels of branch iotons 102c in each branch.

In some embodiments, artificial neural network 202 may have a flat or web structure, as illustrated in FIG. 2E. In this configuration, each ioton 102 may connect to any number of other iotons 102 in the network, subject to processing power and communication range. In some embodiments, iotons on the network may communicate with other iotons on the network directly, or through one or more intermediate iotons.

In some embodiments, iotons 102 in artificial neural network 202 may be substantially identical in structure. However, individual iotons 102 within the network may exhibit different processing characteristics based upon position within the network, a function of the ioton within the network, number of pairings to an ioton, or any combination thereof. For example, a first ioton on the edge of the network may have more processing power to devote to computation in comparison to a second ioton in the middle of the network that functions as a relay or intermediary between multiple other iotons, while the second ioton may have more processing power used for communication. In some embodiments, individual iotons 102 in the network may adapt and adjust their respective processing parameters during operation in response to ioton workload (e.g., an ioton may begin devote more processing power towards communications in response to receiving a certain number of communication tasks).

While FIGS. 2A-E show only a small number of iotons connected together, it is noted that the invention pertains to such networks in which a vast number of iotons may be networked together. In fact, the eventual population of devices that correspond to the internet-of-things will eventually number in the trillions (or more). Any of those devices can potentially be tied into the current architecture, allowing for an artificial neural network having a tremendously large number of iotons, and hence correspondingly expansive performance capacities.

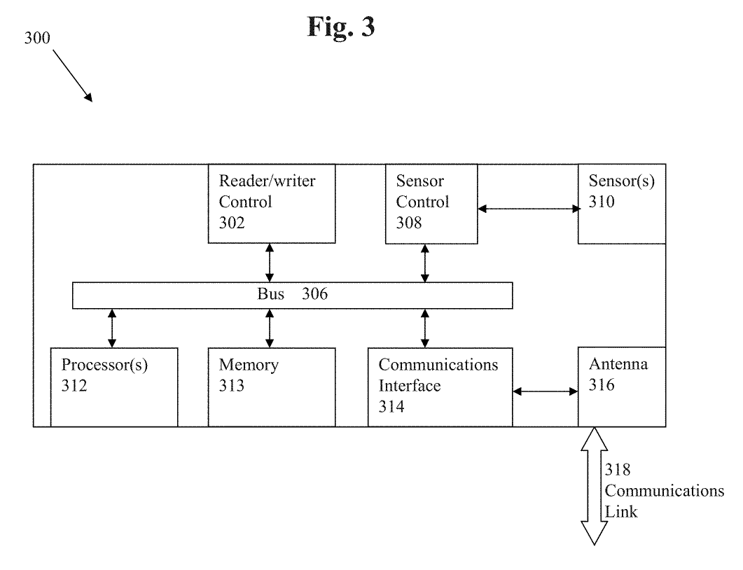

FIG. 3 illustrates a block diagram of an example architecture 300 for a DPU. The architecture 300 includes a bus 306 or other communication mechanism for communicating information, which interconnects subsystems and devices, such as processor 312, system memory 313 (e.g., SRAM), communication interface 314, reader/writer control subsystem 302, and sensor controller 308.

The sensor controller 308 controls and communicates with one or more sensors 310. In some embodiments, the sensors 310 correspond to one or more MEMS sensors for speed, acceleration, temperature, moisture, sound, light/image/video capture, chemical detection, GPS location, and/or any other suitable or appropriate sensing functionality.

The communications interface 314 interfaces with an antenna 316 to perform communications functionality. This allows the ioton to form network pairings with other iotons through a communications link 318 (e.g., wireless mesh networking link), to transmit and receive messages, data, and/or instructions with the other iotons. In addition, communications can be exchanged with RFID tags that form the memory component for the iotons.

In some embodiments, the components illustrated in architecture 300 are integrated into a single IC chip. In alternate embodiments, the architecture may be implemented as separate components, e.g., using an external sensory input device that connects to the ioton IC device.

The DPU 300 performs specific operations by having the processor 312 execute one or more sequences of one or more instructions contained in system memory 313. Hard-wired circuitry may be used in place of or in combination with software instructions to implement the invention. Thus, embodiments of the invention are not limited to any specific combination of hardware circuitry and/or software. In one embodiment, the term “logic” shall mean any combination of software or hardware that is used to implement all or part of the invention.

The term “computer readable medium” or “computer usable medium” as used herein refers to any medium that is usable or readable by any computing device, such as the DPU. Such a medium may take many forms, including but not limited to, non-volatile media and volatile media. Non-volatile media includes, for example, optical or magnetic disks. Volatile media includes dynamic memory, such as system memory 313. Common forms of computer readable media includes, for example, RAM, PROM, EPROM, FLASH-EPROM, any other memory chip or cartridge, or any other medium from which a computer can read.

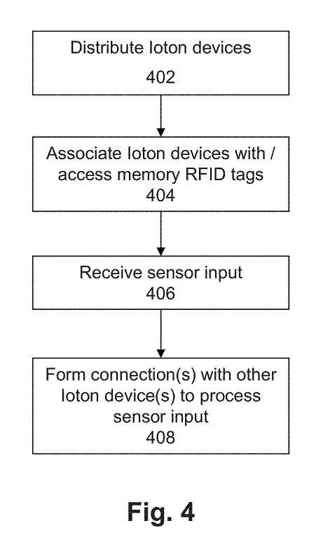

FIG. 4 shows a flowchart of an approach to implement some embodiments of the invention. At 402, DPUs are distributed. For example, this type of distribution may be made in the context of objects that are part of the internet of things. In particular, RFID technologies are now being distributed in many types of items and objects, e.g., within consumer items purchased from ordinary shops and businesses. Thus in some embodiments, DPU distribution comprises establishing a plurality of DPUs in a plurality of different locations where RFID tags and/or other types of sensor or memory devices (e.g., ZigBee modules) are located.

At 404, DPUs are associated with RFID tags. As noted above, the reader functionality within the ioton is capable of accessing the RFID tags within its networking range. The RFID tags are accessed to form the memory components for the ioton. In some embodiments, the DPUs may, in addition to accessing RFID tags, also access one or more ZigBee modules or other types of wireless-enabled modules. The DPU and its associated tags/modules/devices together form an ioton.

At 406, sensory inputs are received by the ioton. The sensory inputs correspond to inputs from any of the sensor devices associated with the ioton. Examples of such inputs include sensory inputs for speed, acceleration, temperature, moisture, sound, light/image/video capture, chemical detection, and/or GPS location. The sensory inputs may be received from a sensor on the DPU, or may be received from sensors located on an RFID tag, ZigBee module, or other associated device that is wirelessly accessible by the DPU.

At 408, connections are formed with other iotons to process the sensory inputs. If the connections are already in existence (previously formed), then this step can be skipped and the existing connection re-used.

The connections between the iotons are formed to implement artificial neural processing. The processing can be used to implement any desired functionality. For example, computational activity can be implemented, where the neural network is an adaptive system that changes its structure based on external or internal information that flows through the network. The computations can be performed, for example, to implement decision-making tools, pattern-matching algorithms, learning systems, and control systems. Some example tasks for the neural network can include function approximations, regression analysis, predictions and modelings, classifications, pattern and sequence recognition, decision making, data processing, data filtering, and compression. Some example applications for the neural network can include system identification and control, game-playing and decision making, pattern recognition, sequence recognition, medical diagnosis, financial applications, data mining, visualization, and filtering.

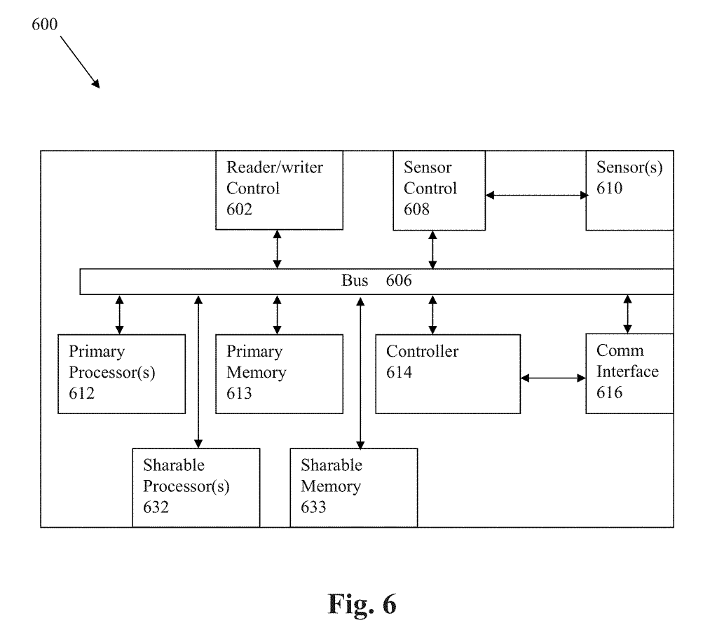

FIG. 6 illustrates a block diagram of an example architecture 600 for another embodiment of a DPU/WT. Similar to the DPU illustrated in FIG. 3, the architecture 600 of FIG. 6 includes a bus 606 or other communication mechanism for communicating information, which interconnects subsystems and devices, such as primary processor(s) 612, primary system memory 613 (e.g., SRAM), communication interface 616, reader/writer control subsystem 602, and sensor controller 608. As before, the sensor controller 608 controls and communicates with one or more sensors 610, such as for example, one or more MEMS sensors for speed, acceleration, temperature, moisture, sound, light/image/video capture, chemical detection, GPS location, and/or any other suitable or appropriate sensing functionality.

The architecture 600 further includes sharable processor(s) 632 and sharable memory 633. These are additional structures are included in the device to be accessed and/or controlled by another DPU/WT when operating as part of a distributed network, e.g., a distributed neural network. These are secondary resources at the local ioton that, along with the sensor(s) 610, may be controlled and/or accessed by a remote ioton.

Therefore, unlike conventional devices that have only a single set of computing resources that are intended for primary use by a local device, the current embodiment additionally comprises a set of computing resource that are intended for access by a remote device. This dual-set of resources permits the primary processor(s) 612 and primary memory 613 to be used in a secure and/or exclusive manner for the local device to utilize, e.g., to minimize security or resource overloading problems that may occur if access/control to the primary local resources are given to an external device/user (e.g., at a remote ioton). Instead, if a remote ioton seeks to access computing resources at the local device, that access is provided by granting control and/or access to the sharable processor(s) 632 and/or sharable memory 633. Physical and/or logical firewalls may be implemented within the architecture 600 to prevent access from the secondary resources to the primary resources. For example, any software loaded into sharable memory 633 for execution by sharable processor(s) 632 would effectively be sandboxed in a physical way by being external to the primary processor(s) and memory. In addition, software controls may be placed over the operating system/firmware of the local ioton to further prevent access to the primary processor(s) or memory from the sharable processor(s) and memory.

The controller 614 operates to control access by a remote ioton to the computing resources within architecture 600. In particular, one or more requests may be received over the communications interface 616 from the remote ioton. Those requests are handled by the controller to provide control and authentication functionality for the request from the remote ioton. If permission is granted, then the controller 614 implements the access or control from the remote ioton, e.g., by providing read/write functionality to the sharable memory and/or sensor(s), or remote access control to the sharable processor(s). Instructions may be passed from the remote ioton to the controller 614 to access the local resources from over the communication link 616. Operations may be performed by having the primary processor(s) 612 and/or sharable processor(s) 632 execute one or more sequences of one or more instructions contained in memory 613 and/or sharable memory 633.

In some embodiments, the components illustrated in architecture 600 can be integrated into a single IC (integrated circuit) chip. In alternate embodiments, the architecture may be implemented as separate components, e.g., using an external sensory input device that connects to the ioton IC device.

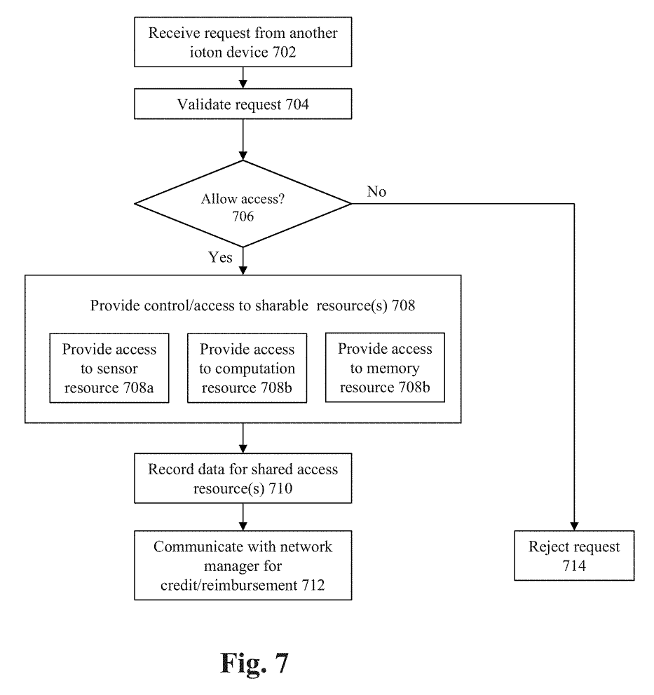

FIG. 7 shows a flowchart of an approach for providing access/control to a remote ioton according to some embodiments of the invention. At 702, a request is received at the local ioton device. The request may be sent from a remote ioton to request control and/or access to one or more resources at the local ioton. For example, the remote ioton may seek to process data at the local ioton from the RFID and sensors, e.g., to process statistical data over time.

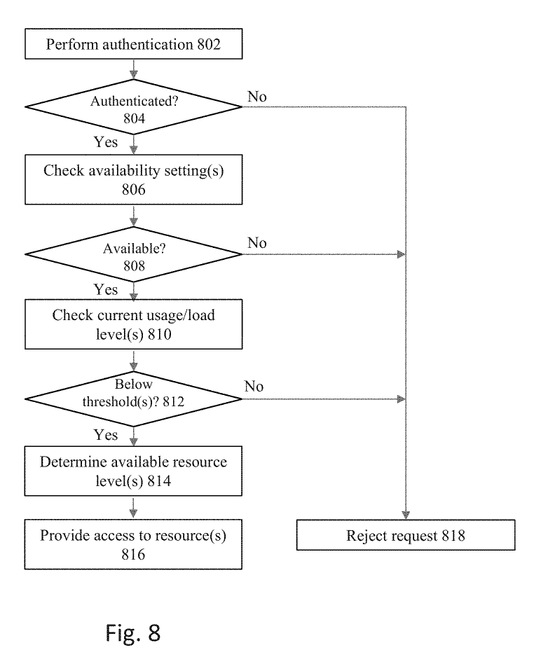

At 704, validation is performed upon the request to determine whether access is permitted to the local resources for the remote request. FIG. 8 shows a flowchart of an approach to determine whether or not a request should be granted to local resources for a remote ioton. At 802, authentication is performed to authenticate access by the remote request/ioton. Any suitable authentication mechanisms may be used to authenticate the request/remote ioton. For example, one or more keys, token, and/or passwords may be provided by the remote ioton for authentication. The authentication may be performed at multiple levels of granularity, e.g., one level of authentication for the identity of the requester ioton, while a second level of authentication/authorization is performed to determine whether the level of access being sought by the remote ioton is grantable. For example, a given remote ioton may be authorized to only access a local sensor but not the sharable processor(s). In this situation, access would be granted if the request pertains to the sensor but denied if the request pertains to control overt the sharable processor(s). It is noted that authentication may be performed either at the local ioton or by a network manager.

If authenticated at step 804, then a check is made of the resource availability settings at the local ioton at step 806. In some embodiments, the local ioton may set the type and/or level of access to be granted to a remote ioton. For example, the local ioton may set a “do not disturb” setting, which would set the local resource as “unavailable”, and therefore would deny access for any requests by a remote ioton even if that remote ioton has been authenticated. On the other end of the spectrum, the local ioton may be set to allow open availability of sharable resources to any remote ioton. Different levels of availability may be configured separately for each of the local resources.

If it is determined, at 808, that the requested local resource has not been turned to an “unavailable” setting, then an additional step can be performed at 810 to check current usage/load levels for the desired resource(s). The local ioton may establish one or more minimum threshold usage levels for granting of access to local resources. One reason for this is because the local ioton may already be using the resources of the local sharable resource being sought in the request, e.g., the local ioton is already using the sharable processor/memory to perform local processing. Another reason is that the shareable resources may already be busy handling work on behalf of another remote ioton. Therefore, to avoid interrupting or resource starving the existing work being performed by the local ioton, a minimum amount of available resource capacity may be checked before granting access to the remote ioton.

If it is determined, at 812, that the desired resources are currently below the minimum usage/load threshold, then an additional step can be performed at 814 to determine the amount of available resources that is grantable to the remote ioton. For example, if the utilization level for the sharable CPU/processor is currently at 50%, and the threshold to allow remote access is 70%, then only 20% sharable CPU/processor utilization is grantable to a request from a remote ioton.

At 816, access is then granted to the desired resources, assuming the above checks have been passed. On the other hand, the request is denied at 818 is one or more of the above conditions are not met.

Returning back to FIG. 7, if it is determined at 706 that access/control should not be granted (e.g., using the approach of FIG. 8), then at 714, the request is denied. On the other hand, if it is determined that access/control should be granted, then at 708, such access/control is provided to the desired resource. At 708a, access may be granted to the sensor resource. For example, access may be granted to access or control the operation of one or more sensors for speed, acceleration, temperature, moisture, sound, light/image/video capture, chemical detection, and/or GPS location. At 708b, access may be granted to one or more computation resources. For example, the request may be granted to allow control access to a local sharable CPU/processor. At 708c, access may be granted to a memory resource. For example, the request may be granted to allow read/write access to a local sharable memory.

At 710, data is recorded for the access to the local ioton resource(s). The general idea is that credits and reimbursements are tracked for access from one ioton to resources on another ioton. This provides a basis for motivating an owner of a local ioton to grant access to a remote ioton, since this allows credits to be earned for that owner's own access to another ioton. Any suitable granularity of exchange may be used to track the credits/reimbursements. For example, tracking may be performed based upon amount of time consumed for a resource, memory/processor utilization, and/or conversion of resource usage into a monetary or other unit based on tracking of usage (e.g., normalized credit amounts). Thereafter, at 712, communications are exchanged with a network manager to record the credits/reimbursements.

It should be noted that multiple remote iotons may be simultaneously given access to the resources of the local ioton. This means that the local ioton may be a concurrent member of multiple distributed processing networks at the same time, e.g., a simultaneous member of multiple neural networks. This policy of granting resource access to multiple remote iotons may be limited based at least upon the availability of resources at the local ioton.

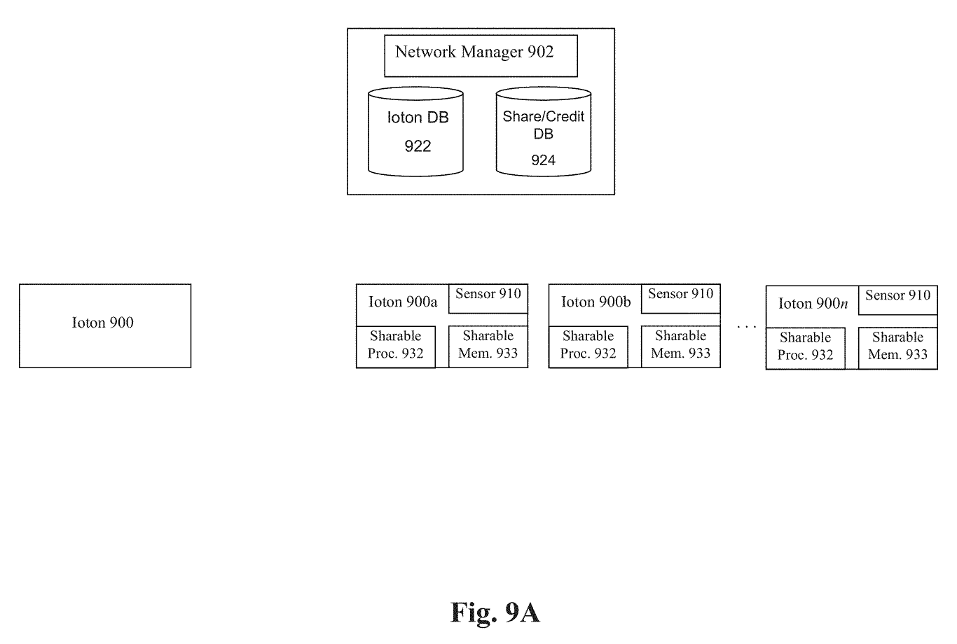

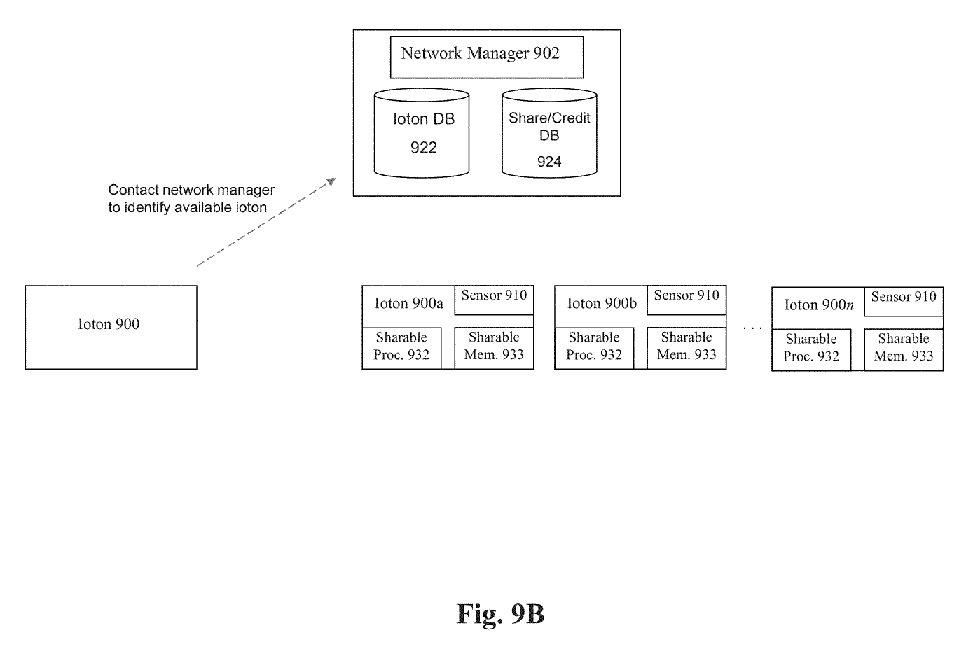

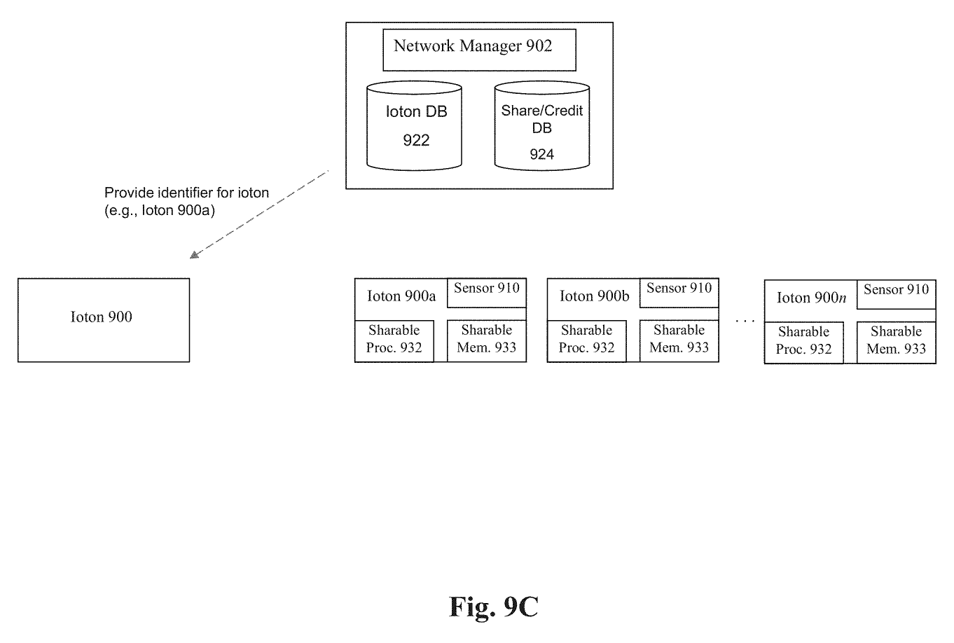

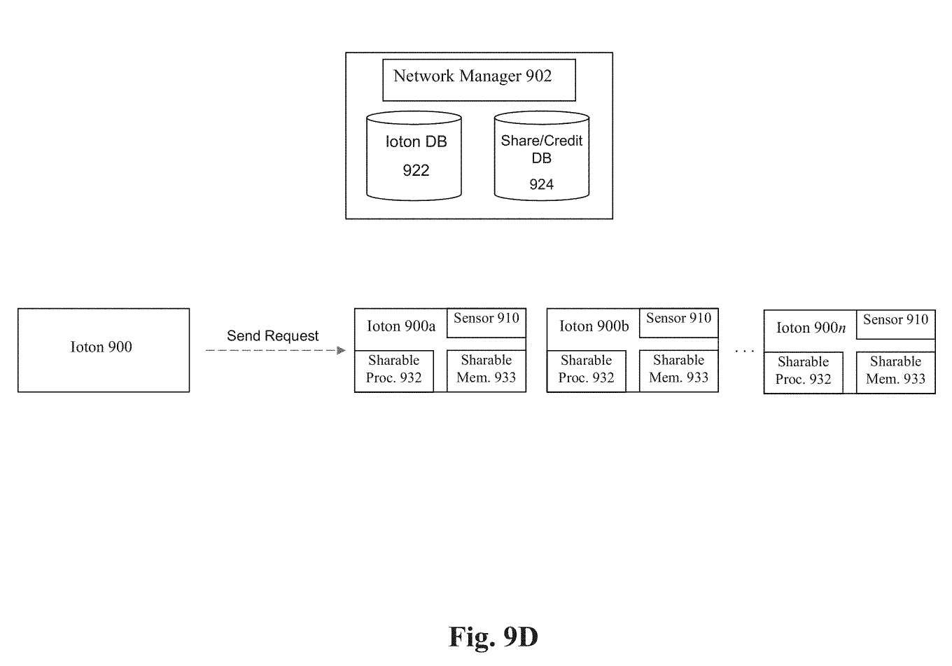

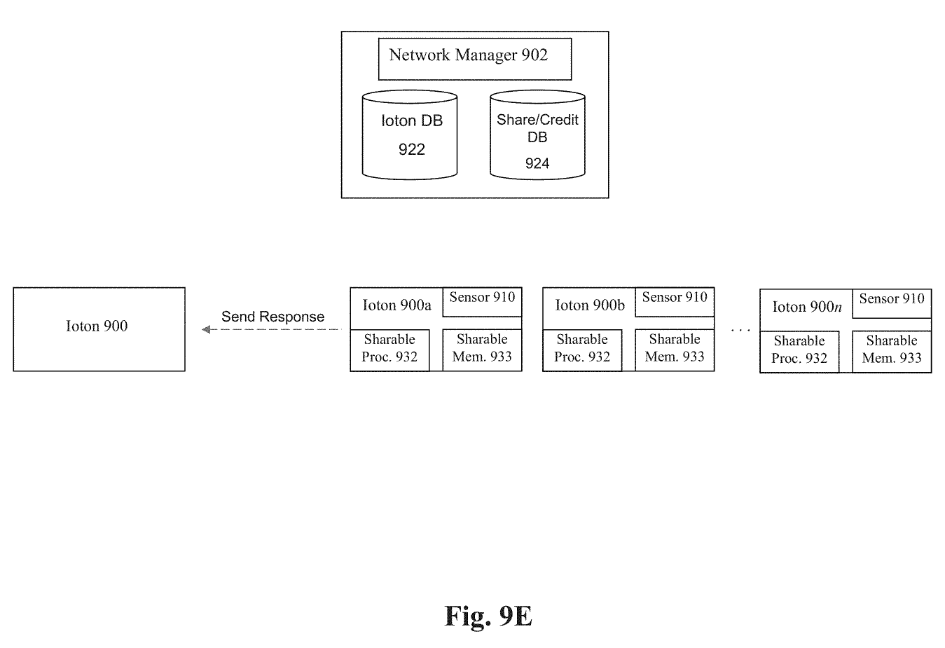

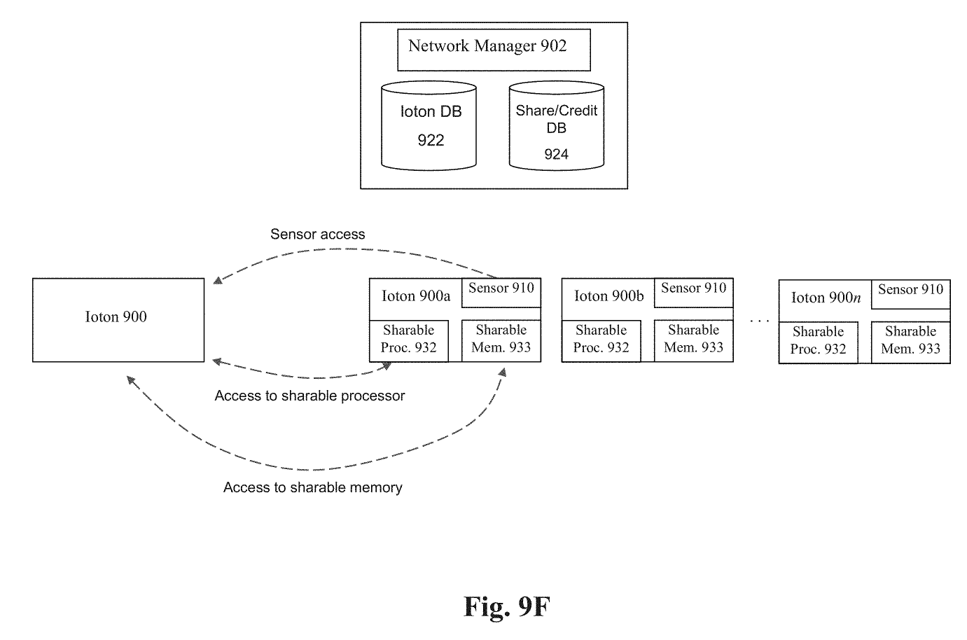

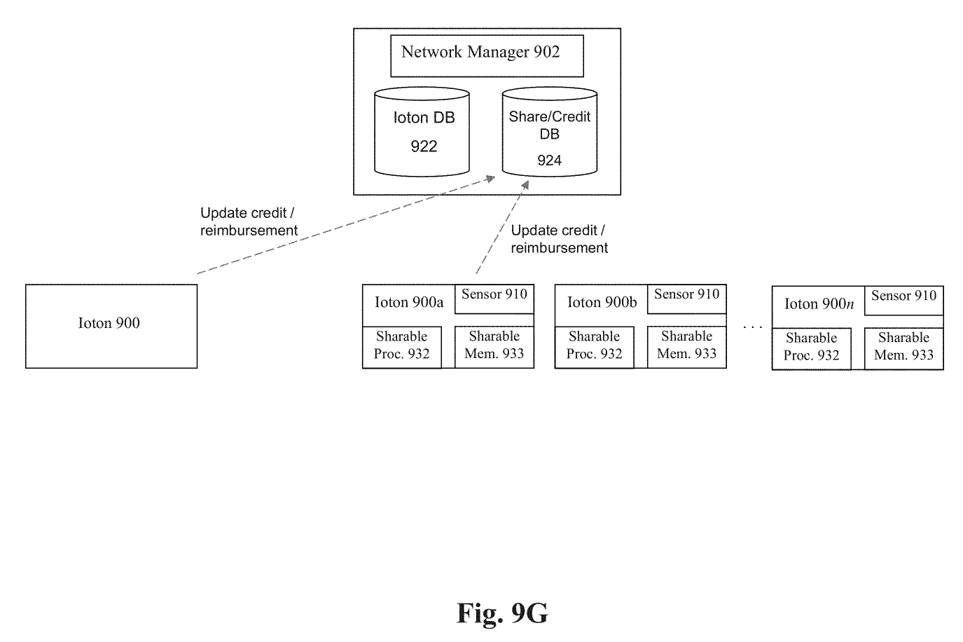

FIGS. 9A-G illustrate an embodiment of the invention. FIG. 9A shows a plurality of iotons, including ioton 900 as well as iotons 900a-n. Each of iotons 900a-n includes local resources that may be the subject of a resource request from remote ioton 900. For example, iotons 900a-n may comprise one or more sensors 910, sharable processor 932, and/or sharable memory 933 that is the subject a request from ioton 900.

A network manager 902 may include or have access to an ioton database (DB) 922, which identifies iotons 900a-n. The ioton database 922 may include various types of metadata about iotons 900a-n, such as whether or not the ioton is currently available for access, the location of the ioton, the capability/resources of the ioton, its authentication information, network protocols, and/or any other information helpful or required to access/identify the ioton for a distributed network. The network manager may include or have access to a share/credit database 924, which identifies the levels of credits and/or reimbursements for the iotons in the network.

Assume that ioton 900 seeks to send a request to another ioton, e.g., to access the resources of the other ioton to form a neural network or any other type of distributed processing network. As shown in FIG. 9B, ioton 900 may contact the network manager 902 to identify a suitable remote ioton to handle the request. The communications to the network manager 902 may include, for example, information regarding the type of resources being sought, a desired location for the ioton or desired locations for the iotons, and/or the type of activity to be performed.

The network manager 902 may use the information sent from the ioton 900 to identify one or more suitable remote iotons to handle the request. For example, a matching operation may be performed to match the parameters of the request to the ioton parameters in the ioton database 922. As shown in FIG. 9C, the identifier(s) for the matched ioton(s) may thereafter be sent to the requesting ioton 900.

Assume that the network manager 902 has identified ioton 900a as a suitable target for the request from the ioton 900. As shown in FIG. 9D, the ioton 900 may then send a request to the identified ioton 900a for access to one or more of its resource(s).

At this point, one or more operations may be performed to determine whether the requested access should be granted. For example, the steps shown in FIG. 8 may be performed to identify whether, and to what extent, access should be granted to ioton 900 to access the resource(s) located at ioton 900a. Based upon this determination, a response is sent back to ioton 900 as shown in FIG. 9E.

Assume that a decision has been made to grant access to ioton 900 to the local resources at ioton 900a. At this point, as shown in FIG. 9F, the ioton 900 may proceed to access the desired control/access to the resource(s) at ioton 900a. For example, ioton 900 may access the local resource of ioton 900a to form a neural network, e.g., where ioton 900a's resource are integrated into the example networks shown in FIGS. 2A-E. As shown in FIG. 9G, the various iotons involved in the remote resource access protocol can update their respective statements of credits and/or reimbursements into the share/credit database 924.

Therefore, what has been described is an improved approach to implement artificial neural networks. The present disclosure provides an advanced neural network that is implemented using an internet-of-things methodology, in which a large number of ordinary items are utilized as the vast infrastructure of a neural network. The ordinary items are equipped within RFID tags to allow them to participate as part of the neural network. Artificial iotons are constructed using a DPU that becomes associated with RFID tags. These artificial iotons forms connections with other iotons, where over time, a huge network of connections are formed. In addition, the disclosure provides an improved architecture, method, and computer program product for implementing an ioton and method of use therefore, in which the ioton includes shareable resources for access by a remote device when forming a distributed processing network, such as a neural network.

The present approach provides a solution to the problems that plague conventional attempts to implement neural networks, since the present invention is capable of implementing neural networks that can achieve desired performance capabilities and implement necessary levels of processing sophistication, complexity, and number of artificial neurons.

In the foregoing specification, the invention has been described with reference to specific embodiments thereof. It will, however, be evident that various modifications and changes may be made thereto without departing from the broader spirit and scope of the invention. For example, the above-described process flows are described with reference to a particular ordering of process actions. However, the ordering of many of the described process actions may be changed without affecting the scope or operation of the invention. The specification and drawings are, accordingly, to be regarded in an illustrative rather than restrictive sense.

1. A device for implementing a neural network, comprising:
a primary processor that performs local processing for operations at a local device;
a primary memory that holds data operated upon by the primary processor for performing the local processing at the local device;
a sharable processor accessible by a remote device to perform processing to implement network operations for the neural network; and
a sharable memory that holds shared data operated upon by the sharable processor to implement the network operations for the neural network.

2. The device of claim 1, in which the device and the remote device correspond to artificial neurons within the neural network.

3. The device of claim 1, in which the device and the remote device are networked together in a peer-to-peer network.

4. The device of claim 1, in which the device further comprises a tag device corresponding to a RFID tag.

5. The device of claim 1, in which the device comprises a reader mechanism and at least one sensor.

6. The device of claim 5, in which the at least one sensor comprises a MEMS sensor.

7. The device of claim 5, in which the at least one sensor performs sensing for at least one of speed, acceleration, temperature, moisture, sound, light/image/video capture, chemical detection, or GPS location.

8. The device of claim 1, wherein the primary processor and primary memory are not accessible to the remote device.

9. A method, comprising:
sending a request from a first device to a second device to form a distributed processing network, wherein the second device comprises a primary processor, a primary memory, a sharable processor, and a sharable memory, the primary processor performing local processing for operations at the second device, and the primary memory holding data operated upon by the primary processor; and
granting access to the first device to access the sharable processor or sharable memory on the second device; the sharable processor accessible by the first device to perform processing on behalf of the first device, and the sharable memory holding shared data operated upon by the sharable processor.

10. The method of claim 9, in which the second device further comprises at least one sensor, and permission is granted to the first device to access at least one sensor.

11. The method of claim 9, further comprising authenticating the request before granting access to the first device.

12. The method of claim 9, further comprising determining an amount of resources to grant for access to the first device.

13. The method of claim 9, wherein the distributed processing network comprises a neural network, and the first and second devices are artificial neurons in the neural network.

14. The method of claim 9, wherein a network manager maintains a database to track devices that are accessible to form the distributed processing network.

15. The method of claim 9, wherein a credit is recorded for resources provided by the second device to the first device.

16. The method of claim 15, wherein a network manager maintains a database to track the credit that is recorded for the resources provided by the second device to the first device.
